(19) United States
(12) Patent Application Publication
(10) Pub. No.: US 2015/0035438 A1
(43) Pub. Date: Feb. 5, 2015

(54) OVER-TEMPERATURE PROTECTING APPARATUS AND OVER-TEMPERATURE PROTECTING METHOD THEREOF

(71) Applicant: Cal-Comp Electronics & Communications Company Limited, New Taipei City (TW)

(72) Inventors: Kwan Ho, New Taipei City (TW); Yao-Sheng Liu, New Taipei City (TW); Chih-Tsung Chen, New Taipei City (TW); Hao-Yuan Wang, New Taipei City (TW)

(73) Assignee: Cal-Comp Electronics & Communications Company Limited, New Taipei City (TW)

(21) Appl. No.: 14/045,796

(22) Filed: Oct. 4, 2013

(30) Foreign Application Priority Data
Aug. 5, 2013 (TW) 102127978

(51) Int. Cl. H05B 33/08

(52) U.S. Cl. CPC H05B 33/089
USPC 315/117

(57) ABSTRACT

An over-temperature protecting apparatus and an over-temperature protecting method thereof are provided. The method includes following steps: detecting the temperature of the over-temperature protecting apparatus to obtain an adjusting signal and outputting the adjusting signal to a current detection pin of the control chip; adjusting the duty-ratio of the pulse-width modulated signal by the control chip output from the gate output pin according to the adjusting signal received by the current detection pin.

### CROSS-REFERENCE TO RELATED APPLICATION

This application claims the priority benefit of Taiwan application serial no. 102127978, filed on Aug. 5, 2013. The entirety of the above-mentioned patent application is hereby incorporated by reference herein and made a part of this specification.

### BACKGROUND OF THE INVENTION

1. Field of the Invention

The invention generally relates to a protecting apparatus, and more particularly, to an over-temperature protecting apparatus and an over-temperature protecting method thereof.

2. Description of Related Art

Along with development day by day of the lighting industry, light-emitting diode (LED) bulbs have gradually substitute the traditional halogen lamp to play a major role in the current lighting field. In terms of a general LED, itself is not luminous, so that, it must be employed a driving circuit module to provide a power to achieve light-emitting functions. The LED features long lifetime, high efficiency and low environment pollution.

However, the driven LED would emit light and produce heat to rise up the temperature thereof. At the time, if the LED driving circuit is unable to sense the temperature of the LED, the LED driving circuit is unable to conduct corresponding adjustment in response to the change of temperature. As a result, during the temperature rising up of the LED, the driving voltage and the current flowing through the LED still stay unchanged, and an over-high temperature may degrade the electrical performance of the LED or shorten the lifetime thereof.

In order to reduce the degrading of the electrical performance of the LED and shortening the lifetime thereof, the most of current LED driving circuits use a negative temperature-coefficient thermistor coupling to a temperature-sensing voltage pin of a control chip so that the control chip can adjust the current to be output to the LED according to the change of the temperature and thereby adjust the luminance of the LED. Although such scheme can effectively control the temperature of the LED, but such adjustment is a stepwise adjustment for controlling the control chip to adjust the current to be output to the LED according to the temperature-sensing voltage, so that a noticed bright and dark flickering situation easily occurs with the bulb wherein the LED serves as the light-source and the lighting quality is seriously affected.

### SUMMARY OF THE INVENTION

Accordingly, the invention is directed to an over-temperature protecting apparatus and an over-temperature protecting method thereof able to avoid the LED from producing the noticed bright and dark flickering situation.

An over-temperature protecting apparatus includes a control chip, a converter unit and a detection unit. The control chip has a current detection pin and a gate output pin. The gate output pin is configured to output a pulse-width modulated signal. The converter unit is coupled to the gate output pin to receive an operating voltage so as to convert the operating voltage into a driving current according to the pulse-width modulated signal for driving an LED unit. The detection unit is coupled to the current detection pin and the converter unit to detect the temperature of the over-temperature protecting apparatus and accordingly output an adjusting signal to the current detection pin, and then, the control chip adjusts the duty-ratio of the pulse-width modulated signal according to the adjusting signal.

In an over-temperature protecting method of an over-temperature protecting apparatus of the invention, the over-temperature protecting apparatus includes a control chip. The over-temperature protecting method of the over-temperature protecting apparatus includes following steps: detecting the temperature of the over-temperature protecting apparatus and accordingly outputting an adjusting signal to a current detection pin of the control chip; adjusting the duty-ratio of the pulse-width modulated signal output from the control chip according to the adjusting signal; and converting the operating voltage into a driving current according to the pulse-width modulated signal so as to drive the LED unit.

Based on the depiction above, the invention uses a detection unit to output an adjusting signal obtained by detecting the temperature of the over-temperature protecting apparatus to the current detection pin of the control chip, so that the control chip adjusts the duty-ratio of the pulse-width modulated signal output to the converter unit according to the voltage received by the current detection pin thereof, which can avoid the current output to the LED unit from noticed stepwise variation and further avoid the LED from noticed bright and dark flickering.

In order to make the features and advantages of the present invention more comprehensible, the present invention is further described in detail in the following with reference to the embodiments and the accompanying drawings.

### BRIEF DESCRIPTION OF THE DRAWINGS

FIG. 1 is a schematic diagram of an over-temperature protecting apparatus according to an embodiment of the invention.

FIG. 2 is a schematic diagram of an over-temperature protecting apparatus according to another embodiment of the invention.

FIG. 3 is a schematic diagram of an over-temperature protecting apparatus according to yet another embodiment of the invention.

FIG. 4 is a flowchart diagram of an over-temperature protecting method according to an embodiment of the invention.

### DESCRIPTION OF THE EMBODIMENTS

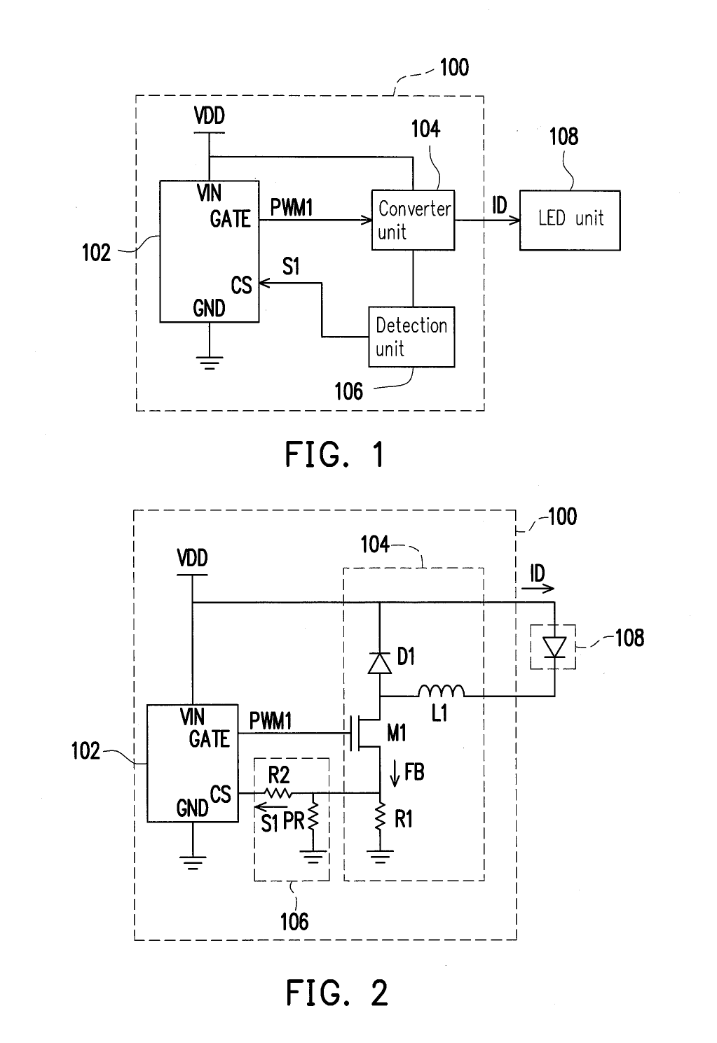

FIG. 1 is a schematic diagram of an over-temperature protecting apparatus according to an embodiment of the invention. Referring to FIG. 1, an over-temperature protecting apparatus 100 includes a control chip 102, a converter unit 104 and a detection unit 106. The control chip 102 can be such as chip in iWatt 361X series, which the invention is not limited to. The control chip 102 has a voltage input pin VIN, a ground pin GND, a current detection pin CS and a gate output pin GATE. The converter unit 104 is coupled to the gate output pin GATE of the control chip 102, the detection unit 106 and an LED unit 108. The detection unit 106 is coupled to the current detection pin CS of the control chip 102. In addition, the voltage input pin VIN of the control chip 102 is coupled to an operating voltage VDD and the ground pin GND is coupled to a grounding terminal.

The gate output pin GATE of the control chip 102 outputs a pulse-width modulated signal PWM1, and the converter unit 104 can convert the received operating voltage VDD into a driving current ID according to the pulse-width modulated signal PWM1 so as to drive the LED unit 108 coupled to the converter unit 104. The detection unit 106 is configured to detect the temperature of the over-temperature protecting apparatus 100 and outputs an adjusting signal S1 to the current detection pin CS of the control chip 102 according to the temperature of the over-temperature protecting apparatus 100. So, the control chip 102 is able to adjust the duty-ratio of the pulse-width modulated signal PWM1 output from the control chip 102 according to the adjusting signal S1 and further adjust the luminance of the LED unit 108. The voltage of the adjusting signal S1 herein gets smaller along with the rising-up of the temperature of the over-temperature protecting apparatus 100 and gets larger along with the falling-down of the temperature of the over-temperature protecting apparatus 100. Meanwhile, the control chip 102 increases the duty-ratio of the pulse-width modulated signal PWM1 along with the rising-up of the voltage of the adjusting signal S1 and decreases the duty-ratio of the pulse-width modulated signal PWM1 along with the falling-down of the voltage of the adjusting signal S1.

In this way, through using the detection unit 106 to detect the temperature of the over-temperature protecting apparatus 100 to obtain the adjusting signal S1 and output the adjusting signal S1 to the current detection pin CS of the control chip 102, the control chip 102 is able to adjust the duty-ratio of the pulse-width modulated signal PWM1 output to the converter unit 104 according to the voltage received by the current detection pin CS thereof. In comparison with the prior art, such adjustment way can have a more linear and smoother output current adjustment curve, which can avoid the current output to the LED unit 108 from noticed stepwise variation and further avoid the LED from noticed bright and dark flickering.

FIG. 2 is a schematic diagram of an over-temperature protecting apparatus according to another embodiment of the invention. Referring to FIG. 2, in more details, the converter unit 104 of the over-temperature protecting apparatus 100 is, for example, a buck circuit. The converter unit 104 includes a power transistor M1, a rectifier diode D1, an inductor L1 and a resistor R1. The cathode of the rectifier diode D1 is coupled to the operating voltage VDD and the LED unit 108, the anode of the rectifier diode D1 is coupled to the drain of the power transistor M1, and the inductor L1 is coupled to between the drain of the power transistor M1 and the LED unit 108. In the embodiment, the LED unit 108 is implemented by a single LED, which the actual applications are not limited to. The LED unit 108 can be an LED string as well or a plurality of LED strings connected in parallel and so on. The gate of the power transistor M1 is coupled to the gate output pin GATE of the control chip 102, the source is coupled to an end of the resistor R1 and the other end of the resistor R1 is coupled to the grounding terminal. It should be noted that although the converter unit 104 in the embodiment is a buck circuit, but the actual is not limited to. The converter unit 104 can be a boost circuit, a boost-buck circuit, a push-pull circuit, a forward converter circuit or a flyback converter circuit.

The detection unit 106 in the embodiment includes a positive temperature-coefficient thermistor PR and a resistor R2, in which the resistor R2 is coupled to between the current detection pin CS of the control chip 102 and the source of the power transistor M1, and the positive temperature-coefficient thermistor PR is coupled to between the source of the power transistor M1 and the grounding terminal.

As shown by FIG. 2, the power transistor M1 is controlled by the pulse-width modulated signal PWM1 output from the gate output pin GATE of the control chip 102 to change the conduction state thereof and thereby to produce the driving current ID at the output terminal of the converter unit 104 to drive the LED unit 108. The more the duty-ratio of the pulse-width modulated signal PWM1, the higher the luminance of the LED unit 108 is. On the contrary, the smaller the duty-ratio of the pulse-width modulated signal PWM1, the lower the luminance of the LED unit 108 is. Thus, by changing the duty-ratio of the pulse-width modulated signal PWM1 input to the gate of the power transistor M1, the luminance of the LED unit 108 gets adjusted.

The source of the power transistor M1 can provide a feedback current signal FB, which after flowing through the detection unit 106 is converted into the adjusting signal S1 to be input to the current detection pin CS of the control chip 102. As shown by FIG. 2, when the temperature of the over-temperature protecting apparatus 100 rises up, the resistance of the positive temperature-coefficient thermistor PR gets rising-up as well. The resistor R2 is a fixed resistor, therefore, the voltage signal flowing to the current detection pin CS of the control chip 102 gets smaller which makes the control chip 102 reduce the duty-ratio of the pulse-width modulated signal PWM1 according to the voltage signal of the current detection pin CS thereof and further reduce the driving current ID of the LED unit 108 to achieve the goal of over-temperature protecting.

Similarly, when the temperature of the over-temperature protecting apparatus 100 falls down, the resistance of the positive temperature-coefficient thermistor PR gets falling-down as well. At the time, the voltage signal flowing to the current detection pin CS of the control chip 102 gets larger which makes the control chip 102 increase the duty-ratio of the pulse-width modulated signal PWM1 according to the voltage signal of the current detection pin CS thereof and further increase the driving current ID of the LED unit 108.

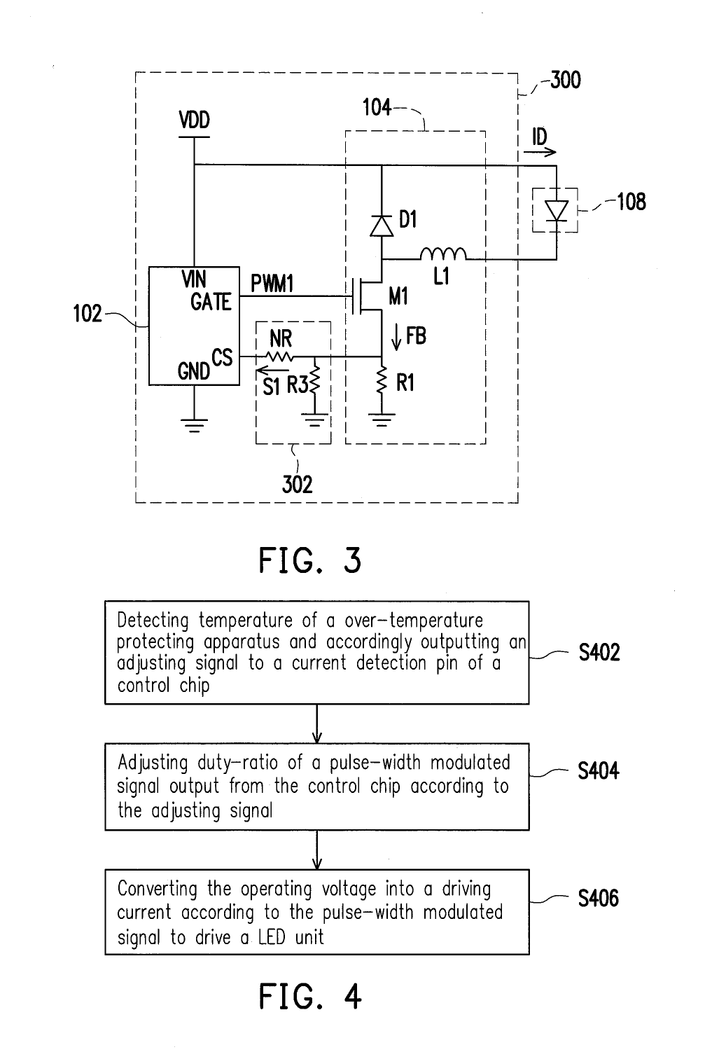

FIG. 3 is a schematic diagram of an over-temperature protecting apparatus according to yet another embodiment of the invention. Referring to FIG. 3, the difference of an over-temperature protecting apparatus 300 of the embodiment from the over-temperature protecting apparatus 100 of the embodiment of FIG. 2 rests in that the detection unit 302 of the over-temperature protecting apparatus 300 in the embodiment includes a negative temperature-coefficient thermistor NR and a resistor R3. The negative temperature-coefficient thermistor NR is coupled to between the current detection pin CS of the control chip 102 and the source of the power transistor M1, and the resistor R3 is coupled to between the source of the power transistor M1 and the grounding terminal.

As shown by FIG. 3, when the temperature of the over-temperature protecting apparatus 300 rises up, the resistance of the negative temperature-coefficient thermistor NR gets falling-down as well. The resistor R3 is a fixed resistor, therefore, the voltage signal flowing to the current detection pin CS of the control chip 102 gets smaller which makes the control chip 102 reduce the duty-ratio of the pulse-width modulated signal PWM1 according to the voltage signal of the current detection pin CS thereof and further reduce the driving current ID of the LED unit 108 to achieve the goal of over-temperature protecting.

Similarly, when the temperature of the over-temperature protecting apparatus 300 falls down, the resistance of the negative temperature-coefficient thermistor NR gets rising-up as well. At the time, the voltage signal flowing to the current detection pin CS of the control chip 102 gets larger which makes the control chip 102 increase the duty-ratio of the pulse-width modulated signal PWM1 according to the voltage signal of the current detection pin CS thereof and further increase the driving current ID of the LED unit 108.

FIG. 4 is a flowchart diagram of an over-temperature protecting method according to an embodiment of the invention. Referring to FIG. 4, the above-mentioned over-temperature protecting method of an over-temperature protecting apparatus can include following steps. First, the temperature of the over-temperature protecting apparatus is detected and accordingly an adjusting signal is output to a current detection pin of the control chip (step S402), wherein the voltage of the adjusting signal gets smaller along with the rising-up of the temperature of the over-temperature protecting apparatus and gets larger along with the falling-down of the temperature of the over-temperature protecting apparatus. Next, the duty-ratio of the pulse-width modulated signal output from the control chip is adjusted according to the adjusting signal (step S404), wherein the way of adjusting the duty-ratio of the pulse-width modulated signal can be, for example, increasing the duty-ratio of the pulse-width modulated signal when the voltage of the adjusting signal rises up and reducing the duty-ratio of the pulse-width modulated signal when the voltage of the adjusting signal falls down. Finally, the operating voltage is converted into a driving current according to the pulse-width modulated signal to drive the LED unit (step S406).

In summary, the invention uses a detection unit to output an adjusting signal obtained by detecting the temperature of the over-temperature protecting apparatus to the current detection pin of the control chip, so that the control chip adjusts the duty-ratio of the pulse-width modulated signal output to the converter unit according to the voltage received by the current detection pin thereof, which can avoid the current output to the LED unit from noticed stepwise variation and further avoid the LED from noticed bright and dark flickering.

What is claimed is:

1. An over-temperature protecting apparatus, comprising:
a control integrated circuit, having a current detection pin and a gate output pin, wherein the gate output pin is configured to output a pulse-width modulated signal;
a converter unit, coupled to the gate output pin, receiving an operating voltage and converting the operating voltage into a driving current according to the pulse-width modulated signal so as to drive a light-emitting diode unit; and
a detection unit, coupled to the current detection pin and the converter unit to detect the temperature of the over-temperature protecting apparatus and accordingly output an adjusting signal to the current detection pin, and then, the control integrated circuit adjusts the duty-ratio of the pulse-width modulated signal according to the adjusting signal.

2. The over-temperature protecting apparatus as claimed in claim 1, wherein the converter unit is a buck circuit and the converter unit comprises:
a power transistor, wherein a gate is coupled to the gate output pin and the power transistor is controlled by the pulse-width modulated signal to change its conduction state;
a rectifier diode, wherein a cathode and an anode are respectively coupled to the operating voltage and a drain of the power transistor;
an inductor, coupled to between the anode of the rectifier diode and the light-emitting diode unit; and
a first resistor, coupled to between a source of the power transistor and a grounding terminal.

3. The over-temperature protecting apparatus as claimed in claim 2, wherein the detection unit comprises:
a positive temperature-coefficient thermistor, coupled to between the source of the power transistor and a grounding terminal; and
a second resistor, coupled to between the source of the power transistor and the current detection pin.

4. The over-temperature protecting apparatus as claimed in claim 2, wherein the detection unit comprises:
a negative temperature-coefficient thermistor, coupled to between the source of the power transistor and the current detection pin; and
a second resistor, coupled to between the source of the power transistor and a grounding terminal.

5. The over-temperature protecting apparatus as claimed in claim 1, wherein the control integrated circuit increases the duty-ratio of the pulse-width modulated signal along with the rising-up of the voltage of the adjusting signal and decreases the duty-ratio of the pulse-width modulated signal along with the falling-down of the voltage of the adjusting signal.

6. The over-temperature protecting apparatus as claimed in claim 1, wherein the voltage of the adjusting signal gets smaller along with the rising-up of the temperature of the over-temperature protecting apparatus.

7. The over-temperature protecting apparatus as claimed in claim 1, wherein the converter unit is selected one among a buck circuit, a boost circuit, a boost-buck circuit, a push-pull circuit, a forward converter circuit or a flyback converter circuit.

8. An over-temperature protecting method of an over-temperature protecting apparatus, wherein the over-temperature protecting apparatus comprises a control integrated circuit, and the over-temperature protecting method of the over-temperature protecting apparatus comprises:
detecting temperature of the over-temperature protecting apparatus and accordingly outputting an adjusting signal to a current detection pin of the control integrated circuit;
adjusting duty-ratio of the pulse-width modulated signal output from the control integrated circuit according to the adjusting signal; and
converting the operating voltage into a driving current according to the pulse-width modulated signal.

9. The over-temperature protecting method of an over-temperature protecting apparatus as claimed in claim 8, wherein the step of adjusting duty-ratio of the pulse-width modulated signal output from the control integrated circuit according to the adjusting signal comprises:
increasing the duty-ratio of the pulse-width modulated signal along with the rising-up of the voltage of the adjusting signal; and
decreasing the duty-ratio of the pulse-width modulated signal along with the falling-down of the voltage of the adjusting signal.

10. The over-temperature protecting method of an over-temperature protecting apparatus as claimed in claim 8, wherein the voltage of the adjusting signal gets smaller along with the rising-up of the temperature of the over-temperature protecting apparatus and gets larger along with the falling-down of the temperature of the over-temperature protecting apparatus.

11. The over-temperature protecting method of an over-temperature protecting apparatus as claimed in claim 9, wherein the voltage of the adjusting signal gets smaller along with the rising-up of the temperature of the over-temperature protecting apparatus and gets larger along with the falling-down of the temperature of the over-temperature protecting apparatus.
